(19) United States
(12) Patent Application Publication
(10) Pub. No.: US 2005/0136779 A1
(43) Pub. Date: Jun. 23, 2005

(54) Process for reinforcing a hydro-entangled pulp fibre material, and hydro-entangled pulp fibre material reinforced by the process

(75) Inventors: Anders Stralin, Torslanda (SE); Mikael Strandqvist, Lindome (SE)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS AB, GOTEBORG (SE)

(21) Appl. No.: 11/017,690

(22) Filed: Dec. 22, 2004

Related U.S. Application Data
(60) Provisional application No. 60/530,901, filed on Dec. 22, 2003.

(51) Int. Cl. B32B 5/06

(52) U.S. Cl. 442/408; 28/107; 442/415; 442/416

(57) ABSTRACT

A process for reinforcing a hydro-entangled pulp fibre material, wherein pulp fibres, including pulp fines, and water are mixed in order to form a fibre suspension which is dewatered and forms a precursor fibre web which is hydro-entangled at a maximum water-jet pressure higher than 85 bar and then dried. Reinforcement fibres, having a fibre length above 5 mm, are introduced into the process and a small amount from about 0.5 to about 10 g/m² dry solids of a copolymer dispersion is applied as a substantially continuous coating onto the precursor web in a wet state enabling the copolymer dispersion to migrate in a z-direction in order to become uniformly distributed throughout the web after the drying, resulting in a reinforced fibre network capable of binding and retaining a majority of the pulp fibres and any remaining fines within the material while maintaining a low material stiffness.

### CROSS REFERENCE TO RELATED APPLICATION

This application claims the 35 USC 119(e) benefit of prior U.S. Provisional application 60/530,901 filed on Dec. 22, 2003.

### FIELD OF THE INVENTION

The present invention relates to a process for reinforcing a hydro-entangled pulp fibre material, and to a reinforced hydro-entangled pulp fibre material which has been subjected to the process.

The reinforced hydro-entangled pulp fibre material is particularly well suited for conversion into industrial wipes, but can be utilised in many other applications which require a relatively inexpensive, textile-like nonwoven material with high absorption capacity for water, organic solvents, oil and grease, high dry and wet strength, low dry and wet linting, and low stiffness.

### BACKGROUND OF THE INVENTION

Hydro-entangled nonwoven materials can be used in a variety of applications, e.g. for industrial wipes, baby diapers, sanitary napkins, data diskette liners, etc.

The hydro-entanglement process per se, and the associated equipment and technology, are well-known to the skilled person.

A low degree of lint release is required in many of the applications where hydro-entangled nonwoven materials are utilised. The water-jet treatment in the hydro-entangling process removes some loose fibres and debris. However, it has been found that the presently available hydro-entangled nonwoven materials still may exhibit a lint release level which is higher than desired, either in a dry state (dry linting) or in a wet state (wet linting), or both. This problem is particularly pronounced when hydro-entangled non-woven materials containing pulp fibres are concerned.

A number of different methods which are intended to improve the durability of hydro-entangled nonwoven materials have been proposed.

Accordingly, EP 0 411 752 A1 describes a method for hydro-entangling a nonwoven fibrous sheet material to significantly increase the strength thereof at low latex add-on values which employs small diameter jets of high-pressure water in the form of coherent streams that concentrate the hydraulic energy over a distance equal to approximately the diameter of the fibres being entangled. A relatively low pressure is employed for the fibre rearrangement along with a synergistic effect of wood pulp and long polyester fibres coupled with small amounts of latex to achieve the unexpectedly high strengths within these light weight materials. The latex binder, generally an acrylic latex binder, is applied onto the fibrous web after drying, e.g. in a print-bonding station, wherein the pick-up of latex binder falls within a range of about 3-20%, preferably 3-15%, based on the total weight of the treated material. According to EP 0 411 752 A1, the resultant sheet material possesses excellent uniformity of fibre distribution and improved strength characteristics over those typically obtained from prior art water jet entanglement processes requiring 300-2000/% the entanglement energy employed in the described process.

Furthermore, U.S. Pat. No. 6,103,061 describes a method of making a nonwoven composite material. The method includes the steps of providing a hydraulically entangled web containing a fibrous component and a nonwoven layer of substantially continuous filaments, applying a bonding material to at least one side of said web, and creping said at least one side of the hydraulically entangled web. The bonder material may be an aqueous mixture including a curable latex polymer, a pigment and a cure promoter. U.S. Pat. No. 6,103,061 also describes a nonwoven composite material made of a hydraulically entangled web including a fibrous component, a nonwoven layer of substantially continuous filaments, and regions containing bonder material covering at least a portion of at least one side of the composite material, wherein at least one side of the web has been creped. According to U.S. Pat. No. 6,103,061, the bonding material may be a conventional adhesive such as e.g. an acrylate, a vinyl acetate, a vinyl chloride, or a methacrylate type adhesive. The binder material may for example be applied to cover from about 10% to about 60%, desirably from about 20% to about 40%, of the surface area of each side of the fabric. When the binder material is applied to each side of the fabric, the total add on will be from about 4% to about 30% by weight. The bonding material is applied on the web in a pattern, e.g. a grid-like pattern, a fish-scale pattern, discrete points or the like.

EP 0 538 971 A2 discloses a nonwoven liner for a diskette cartridge which is made of hydro-entangled fibres and impregnated with a small amount of binder which is uniformly distributed throughout the fabric. According to EP 0 538 971 A2, the binder comprises no more than 5% by weight and preferably between 1.5-3.0% by weight of the fabric, wherein it is claimed that the low concentration of binder ensures that the liner surface does not become totally coated with plastic film that reduces cleaning ability, but still provides improvements in tensile strength and debris reduction and ensures a low risk of chemical attack of the disk media surface. According to EP 0 538 971 A2, the fabric is produced from staple length fibres which typically have a denier in the range of 0.5-6 and a length of a half inch to several inches. The hydro-entangled fabric is claimed to clean the disk media more efficiently, to have less fibre debris, to contain less environmental contaminants, to be substantially loftier, and to be cut with cleaner edges that standard thermally bonded diskette liners. According to EP 0 538 971 A2, the low concentration of binder provides unexpected gains in strength, debris reduction, flexural rigidity, and a dramatic increase of the dimensional stability measured as force to elongate by 1%, i.e. an increased tensile stiffness.

EP 0 530 113 B1 describes a continuous process for producing a spunlace non-woven cotton fabric, which consists in advancing a non-woven cotton fibre fabric, interlacing these fibres by means of a plurality of pressurized water jets, drying the interlaced fabric, and finally collecting the obtained fabric. According to EP 0 530 113 B1, the process further includes to drain the free water contained in the interlaced fabric, after interlacing and before drying, and to impregnate the drained fabric by using an aqueous solution of a polyamide-amine-epichlorohydrine resin in an amount of 0.2% to 1%, measured as dry solids, of the weight of the cotton fibers and, after having expelled the excess solution, to dry the impregnated fabric, at a temperature sufficient to at least initiate the cross-linking of the deposited PAE-resin.

The above-described processes and hydro-entangled nonwoven materials according to prior art might be capable of reducing the problem with undesired linting, but still exhibit some drawbacks.

It is true that some of the existing hydro-entangled nonwoven materials exhibit a relatively low linting level. However, these materials are constituted primarily or exclusively of expensive raw materials such as long staple fibres or synthetic filaments, or long natural fibres, such as cotton, ramie, flax, etc.

Wood pulp fibres, e.g. originating from a chemical or chemi-thermomechanical pulping process, can be used in hydro-entangled nonwoven materials together with longer fibres, e.g. staple fibres or long natural fibres. Pulp is a much cheaper raw material than long manmade or natural fibres, but contains a lot of fine material, so-called fines. Consequently, an addition of pulp fibres will increase the linting level and especially the wet linting of a hydro-entangled nonwoven material, usually resulting in a wet linting level which is 5-10 times higher than the wet linting level of a hydro-entangled nonwoven material without any pulp fibres. This problem will become more pronounced for pulp-containing nonwoven materials which are hydro-entangled at a high water-jet pressure level, since the high-pressure water-jets will penetrate the fibre web and, in cooperation with the wire supporting the fibre web, create “pores” or channels through the fibre structure. The open fibre structure and high degree of fibre entanglement which are produced by high-pressure entanglement are often necessary in order to achieve the required bulk and absorption and strength properties, e.g. for industrial wipes. Such an open fibre structure, however, will allow pulp fines to escape from the nonwoven material into the environment more easily than from a more dense, papersheet-like fibre structure produced by a low-pressure hydro-entanglement process. This is particularly the case when the fibre material is used for industrial wipes which often are used with organic or water-based solvents, since loose pulp fines within the material will be transported out from the internal pores by the solvent and end up on the surface which is to be wiped. This problem will become more accentuated when polar solvents such as water or alcohol are used, since such solvents will wet the fibres and pulp fines and dissolve any hydrogen bonds which could retain the pulp fines within the open fibre structure.

As is evident from the above-described prior art documents, the linting level of a hydro-entangled nonwoven material can be reduced by means of a suitable chemical binder, e.g. a so-called latex binder. The methods described in the prior art, however, exhibit certain disadvantages. One such disadvantage is that the methods according to prior art usually incorporate the chemical binder in the form of a discontinuous surface pattern. Such a discontinuous surface pattern results in a higher risk of linting since there will be a larger number of unbonded fibres and fine particles, and a very high total add-on of chemical binder will be required in order to get a sufficient reduction of the linting level or a sufficient linting reduction will be impossible. Such a high content of chemical binder will influence the absorption properties of the hydro-entangled nonwoven material adversely and increase the material stiffness, something which is unacceptable for many applications, e.g. industrial wipes.

Even if reinforcement methods which utilise relatively low additions of so-called latex binders have been reported in the prior art, these methods have been directed towards materials being constituted primarily or exclusively of expensive long manmade or natural fibres, or continuous filaments.

As mentioned above, it is also known that hydro-entangled nonwoven materials can be impregnated with polyamide-amine-epichlorohydrine resin (PAE) in order to improve the durability in a wet state. Hydro-entangled nonwoven materials containing PAE-resin, however, will require a comparatively long curing time, sometimes several weeks and preferably at a temperature higher than room temperature, in order to reach the desired high wet strength level. This is impractical and increases the production cost, and the wet linting reduction is often insufficient.

### SUMMARY OF THE INVENTION

Accordingly, a first object of the present invention is to provide a process for reinforcing a hydro-entangled pulp fibre material which eliminates the above-described problems associated with the prior art, including the problem with additional storage time for curing, and which enables production of a hydro-entangled nonwoven material which is constituted primarily of pulp fibres, but which still exhibits a very low linting level and the desired open and textile-like fibre structure and low stiffness level.

According to the invention, this first object is achieved by a process, including the steps of: mixing pulp fibres, including pulp fines, and water in order to form a fibre suspension; dewatering the fibre suspension in order to form a precursor web; hydro-entangling the precursor web at a maximum water-jet pressure higher than 85 bar in order to remove a majority of the pulp fines and create an open fibre structure after the hydro-entangling; and drying the hydro-entangled precursor web in order to form the hydro-entangled fibre material; and further including the steps of: introducing reinforcement fibres, having a fibre length above 5 mm, into the process, in order to give the hydro-entangled precursor web a dry solids content of the reinforcement fibres which is lower than the dry solids content of the pulp fibres and pulp fines; and introducing a copolymer dispersion acting as a chemical binder into the process. According to the invention, a small amount from about 0.5 to about 10 g/m² dry solids of the copolymer dispersion is applied onto the precursor web after the hydro-entangling but before the drying, wherein the copolymer dispersion is applied as a substantially continuous coating onto the precursor web being in a wet state enabling the copolymer dispersion to migrate in a z-direction in order to become uniformly distributed throughout the web after the drying, and the small amount and the uniform distribution result in a reinforced fibre network capable of binding and retaining a majority of the pulp fibres and any remaining pulp fines within the reinforced hydro-entangled pulp fibre material while maintaining a low material stiffness.

A second object of the present invention is to provide a reinforced hydro-entangled pulp fibre material, which can be produced at a relatively low raw material cost, and which exhibits an open fibre structure and excellent absorption properties at the same time as it exhibits a very low linting level and a low material stiffness.

According to the invention, this second object is achieved by means of a reinforced hydro-entangled pulp fibre material, which material has been subjected to a process according to the invention, and which exhibits a basis weight between 50 and 120 g/m², a wet linting value which is lower than 30 particles/cm² when measured as released lint particles/cm² in a Biaxial Shake Linting Test, and a tensile stiffness index √MD×CD which is lower than 260 Nm/g.

### BRIEF DESCRIPTION OF THE DRAWINGS

In the following, the invention will be described in greater detail, and when applicable with reference to the appended drawing, in which:

FIG. 1 is a schematic representation of a four-roll offset gravure roll coater 1 which can be used in a preferred embodiment of the process according to the invention.

### DETAILED DESCRIPTION OF PREFERRED EMBODIMENT

In the following, a preferred embodiment and a number of advantageous alternative embodiments of the present invention will be described in greater detail. Furthermore, results from a series of laboratory trials and from subsequent laboratory testing of material samples from the trials will be reported in order to facilitate the understanding of the invention.

The process according to the invention is intended for reinforcing a hydro-entangled pulp fibre material. In this context, “reinforcing” should be understood as making stronger and/or more elastic and/or more durable and/or less linting in comparison to a web containing 100% pulp fibres.

The process includes the step of mixing pulp fibres, including pulp fines, and water in order to form a fibre suspension. This process step can be performed with raw materials, equipment and process settings which are well known to the skilled person.

The process further includes the step of dewatering the fibre suspension in order to form a precursor web. Also this process step can be performed with equipment and process settings which are well known to the skilled person.

Furthermore, the process includes the step of hydro-entangling the precursor web at a maximum water-jet pressure higher than 85 bar in order to remove a majority of the pulp fines and create an open fibre structure after the hydro-entangling. Also this process step is well known to the skilled person. However, as discussed above, this type of high pressure hydro-entanglement process will create “pores” or channels through the fibre structure which are necessary for achieving the desired physical material properties and which in a process according to prior art, but not in the process according to the invention, will increase the risk of a high wet linting level of the finished material.

The process further includes the step of drying the hydro-entangled precursor web in order to form the hydro-entangled fibre material. The drying can be performed in any suitable dryer, but is preferably performed in a through-drying unit of the type which is wellknown to the skilled person.

The process further includes the step of introducing reinforcement fibres, having a fibre length above 5 mm, into the process, in order to give the hydro-entangled precursor web a dry solids content of the reinforcement fibres which is lower than the dry solids content of the pulp fibres and pulp fines. Preferably, the reinforcement fibres are mixed with the pulp fibres and pulp fines in order to form the above-mentioned fibre suspension which subsequently is dewatered in order to form the precursor web which is to be hydro-entangled. However, it is also conceivable with advantageous embodiments where the reinforcement fibres are introduced in another way, e.g. as continuous filaments, or as a separately formed, second precursor web which is hydro-entangled together with the above-mentioned, first precursor web.

Furthermore, the process includes the step of introducing a copolymer dispersion acting as a chemical binder into the process.

According to the invention, a small amount from about 0.5 to about 10 g/m² dry solids of the copolymer dispersion is applied onto the precursor web after the hydro-entangling but before the drying. According to the invention, the copolymer dispersion is applied as a substantially continuous coating onto the precursor web while the precursor web is in a wet state enabling the copolymer dispersion to migrate in a z-direction in order to become uniformly distributed throughout the web after the drying. According to the invention, the small amount and the uniform distribution result in a reinforced fibre network capable of binding and retaining a majority of the pulp fibres and any remaining pulp fines within the reinforced hydro-entangled pulp fibre material while maintaining a low material stiffness.

In a preferred embodiment of the process according to the invention, the small amount of copolymer dispersion is between 0.5 and 3.6 g/m², when calculated as dry solids (DS) of copolymer dispersion/square meter of reinforced hydro-entangled pulp fibre material. This low add-on of copolymer dispersion onto the wet precursor web will give a linting reduction which is sufficient for most applications, without influencing other physical properties such as stiffness and absorption more than necessary.

In another advantageous embodiment, the dry solids content of the precursor web is between 20 and 30% when applying the small amount of copolymer dispersion between the hydro-entangling and the drying. In this embodiment, the copolymer dispersion is applied directly after the hydro-entanglement step.

In the preferred embodiment, the process further includes a dewatering treatment between the hydro-entanglement and the drying, wherein the dewatering treatment can be accomplished e.g. by means of a suction device. The Thereby, the dry solids content of the precursor web is between 30 and 70%, and preferably between 45 and 55%, when applying the small amount of copolymer dispersion between the dewatering treatment and the drying.

In the preferred embodiment, the copolymer dispersion is applied in the form of an aqueous dispersion having a dry content between 25 and 60%, preferably about 50%.

The copolymer dispersion can be constituted of a number of different polymer combinations and can be provided in the form of various dispersions. However, the copolymer dispersion preferably is applied in the form of a vinyl acetate-ethylene copolymer dispersion.

In a particularly preferred embodiment of the invention, the application of the small amount of copolymer dispersion onto the precursor web after the hydro-entangling but before the drying results in a wet linting of the reinforced hydro-entangled pulp fibre material which, measured as released lint particles/cm² in a Biaxial Shake Linting Test, is reduced to less than 25% of the wet linting of an otherwise similar hydro-entangled pulp fibre material but where the same small amount of copolymer dispersion has been applied onto the precursor web after drying. This embodiment enables the production of a reinforced hydro-entangled pulp fibre material which exhibits a very low wet linting level at a very low add-on of copolymer dispersion.

In the particularly preferred embodiment, the introduction of the small amount of copolymer dispersion into the process most advantageously results in a wet linting of the reinforced hydro-entangled pulp fibre material which, measured as released lint-particles/cm² in a Biaxial Shake Linting Test, is reduced to less than 10%, and preferably to less than 5%, of the wet linting of an otherwise similar hydro-entangled pulp fibre material but which has been reinforced with the reinforcement fibres only. This very dramatic reduction of the wet linting makes the process excellent for production of reinforced hydro-entangled pulp fibre material intended for industrial wipes.

In the particularly preferred embodiment, the introduction of the copolymer dispersion into the process most advantageously results in a tensile stiffness index √MD×CD of the reinforced hydro-entangled pulp fibre material which is increased less than 30% in comparison to a hydro-entangled pulp fibre material which has been reinforced with the reinforcement fibres only. This relatively small stiffness increase means that this embodiment can be used for production of reinforced hydro-entangled pulp fibre materials which are to be used in applications requiring a high level of material flexibility and softness.

In the particularly preferred embodiment, the reinforced fibre network is maintained substantially intact after the drying by means of minimizing friction against any stationary surfaces in the process and in a subsequent converting into a finished product. This minimized friction can be achieved e.g. by means of eliminating any stationary surfaces such as creping doctor blades or the like, and by means of selecting converting machinery which uses rotary machine elements only.

In one advantageous embodiment, the process includes a wetforming unit. The wet-forming unit can be of any suitable type as long as its capable of handling the relatively long reinforcement fibres and of producing a fibre formation which is sufficiently uniform for the subsequent hydro-entanglement.

In the preferred embodiment, however, a foam surfactant is added to the fibre suspension before the dewatering, and the process includes a foamforming unit. The skilled person will be able to find a description of suitable foamforming units in several U.S. patents, in the name of Reiner, Lennart and assigned to SCA Hygiene Products AB of Göteborg, Sweden (formerly Mölnlycke Tissue AB).

In the preferred embodiment, the hydro-entanglement and drying are performed in-line.

It is also preferred that the hydro-entangling is performed with water-jet pressures ranging between 90 and 130 bar, and advantageously at a machine speed exceeding 45 m/min, and preferably exceeding 100 m/min.

Furthermore, it is preferred that the copolymer dispersion is applied in the form of an aqueous dispersion by means of an offset gravure roll coater, e.g. of the type which is commercially available from Paper Converting Machine Company (PCMC), Green Bay, Wis., U.S.A. However, it is also conceivable with embodiments where the copolymer dispersion is applied by means of another suitable equipment, e.g. by means of a spraying equipment.

In the following, a reinforced hydro-entangled pulp fibre material which has been subjected to a process according to the invention will be described in greater detail.

According to the invention, the material exhibits a basis weight between 50 and 120 g/m², a wet linting value which is lower than 30 particles/cm² when measured as released lint particles/cm² in a Biaxial Shake Linting Test, and a tensile stiffness index √MD×CD which is lower than 260 Nm/g. This unique combination of material properties, i.e. a high pulp fibre content, an open fibre structure, and a low wet linting at a relatively low tensile stiffness level, makes the reinforced hydro-entangled pulp fibre material according to the invention very well suited for use in industrial wipes.

In a preferred embodiment of the invention, the reinforced hydro-entangled pulp fibre material exhibits a wet linting value which is lower than 10 particles/cm² when measured as released lint particles/cm² in a Biaxial Shake Linting Test. In the prior art, this very low linting level has only been reached by hydro-entangled nonwoven materials without any pulp fibres, i.e. materials which only can be produced at a relatively high raw material cost.

In a particularly preferred embodiment of the invention, the material exhibits a tensile stiffness index √MD×CD which is lower than 210 Nm/g. This relatively low tensile stiffness level makes the material suitable also for applications where a high material flexibility and softness are required.

In one advantageous embodiment of the invention, the reinforced hydro-entangled pulp fibre material contains between 0.4 and 12 weight-% dry solids of the copolymer dispersion, and more advantageously between 0.8 and 4 weight-%. In the preferred embodiment, the reinforced hydro-entangled pulp fibre material contains between 1.0 and 3.0 weight-% dry solids of the copolymer dispersion. As will be appreciated by the skilled person reading this description, the content of copolymer dispersion will be minimized for each particular case, while taking the required level of physical properties into consideration (e.g. the wet linting level).

Even if any suitable copolymer dispersion can be included in the reinforced hydro-entangled pulp fibre material, it is preferred that the material contains a vinyl acetate-ethylene copolymer dispersion.

The reinforced hydro-entangled pulp fibre material according to the invention preferably contains between 51 and 75 weight-% of pulp fibres. The pulp fibres included in the material are preferably unbleached or bleached softwood or hardwood pulp fibres originating from a chemical or chemi-thermomechanical pulping process.

The reinforced hydro-entangled pulp fibre material preferably contains between 20 and 45 weight-% of reinforcement fibres. The reinforcement fibres preferably include manmade staple fibres, between 0.4 and 2.5 dtex, made from synthetic or natural polymers. However, it is also conceivable with embodiments where other reinforcement fibres are included, e.g. staple fibres with other dimensions or continuous filaments of suitable polymers.

In one advantageous embodiment, the reinforcement fibres include polyethylene, polypropylene (PP), polyester (PET), polyamide, viscose or lyocell fibres, or splitfibres made from these polymers. This embodiment provides a reinforced hydro-entangled pulp fibre material which exhibits physical properties which can be maintained within a narrow quality specification range.

In another embodiment, the reinforcement fibres include natural fibres from cotton, flax, hemp, ramie, milkweed, or other natural fibres exhibiting a fibre length between 5 and 30 mm. This embodiment provides a reinforced hydro-entangled pulp fibre material with a higher degree of biodegradability.

In a particularly advantageous embodiment of the invention, the reinforced hydro-entangled pulp fibre material includes between 54 and 62 weight-% bleached softwood sulphate pulp fibres, between 21 and 29 weight-% PET-fibres, between 13 and 21 weight-% PP-fibres, and between 1.8 and 2.6 weight-% dry solids of vinyl acetate-ethylene copolymer dispersion, wherein the PET- and PP-fibres exhibit fibre dimensions within a range of 1.5-1.9 dtex and 15-25 mm.

Laboratory Trials

A series of pilot trials were conducted in order to simulate a process for reinforcing a hydro-entangled pulp fibre material according to the invention.

In these trials, a commercially available hydro-entangled nonwoven material intended for use in industrial wipes (E-TORK Strong manufactured by SCA Hygiene Products AB) was subjected to different treatments in a pilot-scale equipment for offset gravure roll coating. E-TORK Strong is produced by means of hydro-entangling a precursor web consisting of a mixture of bleached softwood sulphate pulp fibres, polyester staple fibres, and polypropylene staple fibres. The pulp fibre content in the finished nonwoven material is higher than 55 weight-%.

An untreated sample of the hydro-entangled nonwoven material was extracted as a control for subsequent laboratory testing of different physical properties.

The remaining nonwoven web material was coated in the offset gravure roll coater with different pick-up levels of an aqueous copolymer dispersion, Dur-O-Set Elite 20® supplied by Vinamul Polymers (Vinamul DSE-20). The dry solids content of the dispersion was 50/%.

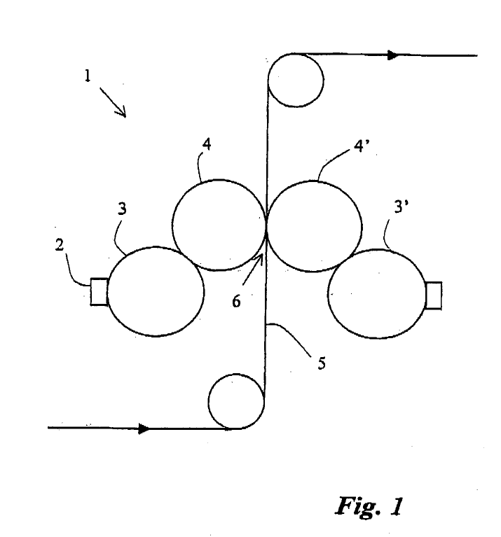

The copolymer dispersion was applied onto the nonwoven webs by means of a 440 mm wide, four-roll offset gravure roll pilot coater 1, as illustrated in FIG. 1. The copolymer dispersion (not shown) is circulated through a doctor blade chamber 2 in connection with a rotating gravure roll 3. The gravure roll 3 picks up copolymer dispersion from the doctor blade chamber and transfers the copolymer dispersion to the offset roll 4. The nonwoven web 5 is gently pressed between the pair of offset rolls 4, 4′, and in the press nip 6 the copolymer dispersion is transferred onto both sides of the nonwoven web.

The peripheral surfaces of the gravure rolls 3, 3′ are engraved with a continuous and very fine pattern in order to produce substantially continuous coating films which can be transferred to the offset rolls 4, 4′ and onto both sides of the nonwoven web 5. A substantially continuous coating across both web faces will be the most favourable for reducing the linting of the coated nonwoven material.

In the trials, both dry nonwoven web material and nonwoven web material which had been prewetted to about 50% dry content were coated on both sides at a machine speed of 50 m/min. In the offset gravure roll coater 1, it was possible to regulate the coating weight by means of adjusting the speed of the gravure roll 3, 3′ in relation to the offset roll 4, 4′ within a range from 10 to 100%. In the trials, the gravure roll speed was set to 10, 20 and 50% of the offset roll speed.

After the coating treatment, samples of the different nonwoven materials were dried in an oven at 130° C. for 5 minutes. The applied coating weights, or pick-up levels, were determined by means of comparing the basis weights before and after coating treatment. The trials where the gravure roll speed was set to 10, 20 and 50% of the offset roll speed, respectively, resulted in a total coating weight (both sides) on the treated nonwoven material of about 2, 5 and 9 g/m², corresponding to 2, 5 and 10 weight-% dry solids of copolymer dispersion.

Results from Laboratory Testing

Samples of the uncoated nonwoven material (control) and samples of the nonwoven materials coated, either in a dry or in a prewetted state, with different coating weights of copolymer dispersion were subjected to laboratory testing.

Table 1 below shows results from wet linting measurements on the different samples. The measurements were performed on dried nonwoven material samples by means of a method called “Biaxial Shake Linting”. This method is based on Standard Test Method IST 160:2 (95) (Aqueous Method for Determining Release of Particulates) and is suitable for determining the linting level of nonwoven materials in a wet state. A 110×160 mm test specimen is cut from the nonwoven material which is to be tested, wherein the longer side of the test specimen corresponds to the machine direction (MD). A thoroughly rinsed plastic container is filled with 800 ml of demineralised water, and the test specimen is placed at the bottom of the container below the water surface. The cap of the plastic container is screwed on, and the plastic container is placed on a biaxial shaking table where it is subjected to shaking for 5 minutes, with a shake setting of 4.5. The test specimen is lifted above the water surface by means of a pair of tweezers and water may pour off for approx. 10 seconds before the test specimen is lifted out of the plastic container. After having ensured that the water in the plastic container is thoroughly mixed, two 50 ml water samples are extracted in two glass beakers. Fibres and particles (>20 μm) which are present in the two water samples are counted in a Kajaani FS-100, Kajaani, Finland. The results are reported as particles/cm² material (mean±standard deviation), wherein the surface area includes both sides of the test specimen.

TABLE 1
Testing results from Biaxial Shake Linting measurements

| Gravure roll/ | | Vinamul DSE-20 | Vinamul DSE-20 |
|---|---|---|---|
| offset roll | Control | coated on | applied on |
| speed → | (uncoated) | dry material | prewetted material |
| Pick-up | [particles/cm²] | [particles/cm²] | [particles/cm²] |
| 10% → 2% | 315 | 52 | 8 |
| or 2 g/m² | | | |
| 20% → 5% | 315 | 53 | 8 |
| or 5 g/m² | | | |
| 50% → 10% | 315 | 34 | 4 |
| or 9 g/m² | | | |

The copolymer dispersion had a 50% dry solids content when it was applied onto the nonwoven material. This high dry content of the copolymer dispersion is advantageous since it reduces the volume requirements in the coating section, and also since less water has to be evaporated in the dryer.

As is evident from the results in Table 1, the coating treatment performed on the nonwoven material in a dry state resulted in a relatively large reduction of the wet linting of the coated nonwoven material. The wet linting value was reduced to between 10.8 and 16.8% of the wet linting value of the untreated control.

However, as is also evident from Table 1, the application of copolymer dispersion on the nonwoven material being in a wet state resulted in a much larger reduction of the wet linting. In this case, the wet linting value was reduced to between 1.3 and 2.5% of the wet linting value of the untreated control.

It is also evident from Table 1 that the copolymer application on prewetted nonwoven material resulted in a wet linting value which, at the same pick-up level, is only 11.8 to 15.4% of the wet linting value exhibited by the nonwoven samples which had been coated in a dry state with the same copolymer dispersion.

This surprising and hitherto unknown effect, i.e. the dramatic wet linting reduction which can be achieved by means of applying a continuous coating of a copolymer dispersion onto a hydro-entangled nonwoven material having a high pulp content and being in a wet state instead of in a dry state is the basis of the present invention. The present inventors believe that one reason for this dramatic effect is that the material in a dry state absorbs the water in the copolymer dispersion very rapidly which results in a poor wetting and an non-uniform distribution of the copolymer dispersion on the fibre surfaces and particularly in the z-direction of the material, whereas the material which is in a wet state when treated allows a much better wetting with copolymer dispersion resulting in a very uniform distribution of the copolymer dispersion throughout the fibre structure and also in the z-direction. The present inventors believe that another reason for the surprising and dramatic effect is that the capillary forces during the subsequent drying will be able to distribute the copolymer dispersion to fibre-fibre crossings within the fibre structure more efficiently in the wet material than in the dry material, since the wet material contains more water acting as a carrier.

Table 2 below is a summary of the results from the laboratory testing of physical material properties performed on the samples from the above-discussed pilot trials.

TABLE 2
Results from laboratory testing of physical material properties

| | | Sample No. | | | | | | |
|---|---|---|---|---|---|---|---|---|
| | | Prior Art | | | INVENTION | | | control |
| Property | Unit | 1 | 2 | 3 | 4 | 5 | 6 | 7 |
| Basis weight | g/m² | 87.5 | 95.3 | 95.2 | 93.3 | 99.5 | 95.8 | 89.0 |
| Thickness 2 kPa | μm | 383 | 403 | 369 | 397 | 417 | 355 | 371 |
| Tensile stiffness index | Nm/g | 159 | 165 | 190 | 199 | 201 | 251 | 156 |
| √MD × CD | | | | | | | | |
| Tensile strength MD, | N/m | 2566 | 3386 | 4327 | 4100 | 4681 | 5021 | 3211 |
| dry | | | | | | | | |
| Tensile strength CD, dry | N/m | 645 | 544 | 583 | 799 | 745 | 853 | 430 |
| Tensile index √MD × CD, | Nm/g | 15 | 14 | 17 | 19 | 19 | 22 | 13 |
| dry | | | | | | | | |
| Stretch MD | % | 15 | 15 | 16 | 18 | 16 | 16 | 16 |
| Stretch CD | % | 40 | 35 | 40 | 51 | 32 | 39 | 50 |
| Stretch √MD × CD | % | 24 | 23 | 25 | 30 | 23 | 25 | 28 |
| Tensile strength MD, | N/m | 1535 | 1973 | 2626 | 2784 | 4162 | 4219 | 936 |
| water | | | | | | | | |
| Tensile strength CD, | N/m | 284 | 292 | 511 | 489 | 748 | 687 | 148 |
| water | | | | | | | | |
| Tensile index √MD × CD, | Nm/g | 7.5 | 8.0 | 12.2 | 12.5 | 17.7 | 17.8 | 4.2 |
| water | | | | | | | | |
| Relative strength, water | % | 51 | 56 | 73 | 64 | 94 | 82 | 32 |
| Absorption DIN, water | g/m² | 309.0 | 311.0 | 269.0 | 282.0 | 285.0 | 228.0 | 349.0 |
| Biaxial Shake Wet | part./ | | | | | | | |
| Linting | cm² | 52 | 53 | 34 | 8 | 8 | 4 | 315 |

The results reported in Table 2 above refer to the following test materials:
1 2% or 2 g/m² Vinamul DSE-20 on DRY E-TORK Strong (PRIOR ART)
2 5% or 5 g/m² Vinamul DSE-20 on DRY E-TORK Strong (PRIOR ART)
3 10% or 9 g/m² Vinamul DSE-20 on DRY E-TORK Strong (PRIOR ART)
4 2% or 2 g/m² Vinamul DSE-20 on PREWETTED E-TORK Strong (INVENTION)
5 5% or 5 g/m² Vinamul DSE-20 on PREWETTED E-TORK Strong (INVENTION)
6 10% or 9 g/m² Vinamul DSE-20 on PREWETTED E-TORK Strong (INVENTION)
7 Untreated E-TORK Strong (CONTROL)

The material testing was performed with methods which should be well-known to the skilled person. Therefore, the test methods will be described only briefly in the following description.

Basis weight was measured by means of determining the weight of a test specimen having a known surface area.

Thickness was measured by means of a conventional thickness meter working at a pressure of 2 kPA.

Tensile strengths, dry and in water, and stretch were measured by means of a commercially available tensile testing equipment: LLoyd Instruments model LRX, Ametek Test and Calibration Instruments, Foreham, Hampshire, England. The test specimens were 50×100 mm, the clamping length 100 mm, the tensioning rate 100 mm/min.

Relative strength in water was calculated from the formula:
(√(tensile MD*CD, water)/√(tensile MD*CD, dry))*100%

Tensile stiffness was calculated from the stress/strain-data recorded in the dry tensile strength measurements by means of the following formula:

$$St = \frac{Δ F}{Δ ɛ} \cdot \frac{1}{w}$$

where
St=tensile stiffness, N/m
F=tensile force, N
ε=elongation in %
w=sample specimen width, m

Tensile stiffness index √MD×CD was calculated by means of the formula:
(√(tensile stiffness MD*tensile stiffness CD))/basis weight.

Absorption DIN was measured in accordance with DIN 54 540.

In the foregoing description, the present invention has been described with reference to different embodiments and results from pilot trials and laboratory testing. However, the present invention is by no means limited to these embodiments or to the reported results, but the scope of the invention is defined in the following claims.

Accordingly, it is also conceivable with embodiments of the present invention where several different copolymer dispersions (instead of only one copolymer dispersion) are utilised in order to reinforce the hydro-entangled pulp fibre material, or embodiments where also a chemical binder of another type is included for additional reinforcement.

1. A process for reinforcing a hydro-entangled pulp fibre material, which comprises the steps of:
mixing pulp fibres, including pulp fines, and water in order to form a fibre suspension;
dewatering said fibre suspension in order to form a precursor web;
hydro-entangling said precursor web at a maximum water-jet pressure higher than 85 bar in order to remove a majority of said pulp fines and create an open fibre structure after said hydro-entangling; and
drying said hydro-entangled precursor web in order to form said hydro-entangled fibre material,
said process further comprising the steps of:
introducing reinforcement fibres, having a fibre length above 5 mm in order to give said hydro-entangled precursor web a dry solids content of said reinforcement fibres which is lower than the dry solids content of said pulp fibres and pulp fines; and
applying a small amount ranging from about 0.5 to about 10 g/m² dry solids of a copolymer dispersion acting as a chemical binder
onto said precursor web after said hydro-entangling but before said drying, said copolymer dispersion being applied as a substantially continuous coating onto said precursor web being in a wet state enabling said copolymer dispersion to migrate in a z-direction in order to become uniformly distributed throughout said web after said drying, said small amount and said uniform distribution resulting in a reinforced fibre network capable of binding and retaining a majority of said pulp fibres and any remaining pulp fines within said reinforced hydro-entangled pulp fibre material while maintaining a low material stiffness.

2. The process according to claim 1, wherein
the small amount of copolymer dispersion is between 0.5 and 3.6 g/m² (DS).

3. The process according to claim 1, wherein
the dry solids content of said precursor web is between 20 and 30% when applying said small amount of copolymer dispersion between said hydro-entangling and said drying.

4. The process according to claim 1, further comprising
a dewatering treatment between said hydro-entanglement and said drying, and
the dry solids content of said precursor web is between 30 and 70% when applying said small amount of copolymer dispersion between said dewatering treatment and said drying.

5. The process according to claim 1, wherein
the copolymer dispersion is applied in the form of an aqueous dispersion having a dry content between 25 and 60%.

6. The process according to claim 1, wherein
the copolymer dispersion is applied in the form of a vinyl acetate-ethylene copolymer dispersion.

7. The process according to claim 1, wherein
the step of applying said small amount of copolymer dispersion onto said precursor web after said hydro-entangling but before said drying results in a wet linting of said reinforced hydro-entangled pulp fibre material which, measured as released lint particles/cm² in a Biaxial Shake Linting Test, is reduced to less than 25% of the wet linting of an otherwise similar hydro-entangled pulp fibre material but where the same small amount of copolymer dispersion has been applied onto said precursor web after drying.

8. The process according to claim 1, wherein the step of applying
said small amount of copolymer dispersion results in a wet linting of said reinforced hydro-entangled pulp fibre material which, measured as released lint particles/cm² in a Biaxial Shake Linting Test, is reduced to less than 10% of the wet linting of an otherwise similar hydro-entangled pulp fibre material but which has been reinforced only with said reinforcement fibres.

9. The process according to claim 1, wherein the step of applying
said copolymer dispersion results in a tensile stiffness index √MD×CD of said reinforced hydro-entangled pulp fibre material which is increased less than 30% in comparison to a hydro-entangled pulp fibre material which has been reinforced with only said reinforcement fibres.

10. The process according to claim 1, wherein
the reinforced fibre network is maintained substantially intact after said drying by minimizing friction against any stationary surfaces in said process and in a subsequent conversion into a finished product.

11. The process according to claim 1, wherein
the process includes a wetforming unit.

12. The process according to claim 1, further comprising adding
a foam surfactant to said fibre suspension before said dewatering, and wherein said process includes a foamforming unit.

13. The process according to claim 1, wherein
the hydro-entanglement and drying are performed in-line.

14. The process according to claim 1, wherein
the hydro-entangling is performed with water-jet pressures ranging between 90 and 130 bar.

15. The process according to claim 1, wherein
the hydro-entangling is performed at a machine speed exceeding 45 m/min.

16. The process according to claim 1, wherein
the copolymer dispersion is applied in the form of an aqueous dispersion by means of an offset gravure roll coater.

17. A reinforced hydro-entangled pulp fibre material which has been subjected to a process according to claim 1, wherein
the material exhibits a basis weight between 50 and 120 g/m², a wet linting value which is lower than 30 particles/cm² when measured as released lint particles/cm² in a Biaxial Shake Linting Test, and a tensile stiffness index √MD×CD which is lower than 260 Nm/g.

18. The reinforced hydro-entangled pulp fibre material according to claim 17, wherein
the material exhibits a wet linting value which is lower than 10 particles/cm² when measured as released lint particles/cm² in a Biaxial Shake Linting Test.

19. The reinforced hydro-entangled pulp fibre material according to claim 17, wherein
the material exhibits a tensile stiffness index √MD×CD which is lower than 210 Nm/g.

20. The reinforced hydro-entangled pulp fibre material according to claim 17, wherein
the material contains between 0.4 and 12 weight-% dry solids of said copolymer dispersion.

21. The reinforced hydro-entangled pulp fibre material according to claim 17, wherein
the material contains between 0.8 and 4 weight-% dry solids of said copolymer dispersion.

22. The reinforced hydro-entangled pulp fibre material according to claim 17, wherein
the material contains a vinyl acetate-ethylene copolymer dispersion.

23. The reinforced hydro-entangled pulp fibre material according to claim 17, wherein
the material contains between 51 and 75 weight-% of said pulp fibres.

24. The reinforced hydro-entangled pulp fibre material according to claim 17, wherein
the pulp fibres included in said material are unbleached or bleached softwood or hardwood pulp fibres originating from a chemical or chemi-thermomechanical pulping process.

25. The reinforced hydro-entangled pulp fibre material according to claim 17, wherein
the material contains between 20 and 45 weight-% of said reinforcement fibres.

26. The reinforced hydro-entangled pulp fibre material according to claim 17, wherein
the reinforcement fibres include manmade staple fibres, between 0.4 and 2.5 dtex, made from synthetic or natural polymers.

27. The reinforced hydro-entangled pulp fibre material according to claim 17, wherein
the reinforcement fibres include polyethylene, polypropylene (PP), polyester (PET), polyamide, viscose or lyocell fibres, or splitfibres made from these polymers.

28. The reinforced hydro-entangled pulp fibre material according to claim 17, wherein
the reinforcement fibres include natural fibres from cotton, flax, hemp, ramie, milkweed, or other natural fibres exhibiting a fibre length between 5 and 30 mm.

29. The reinforced hydro-entangled pulp fibre material according to claim 17, wherein the material includes between 54 and 62 weight-% bleached softwood sulphate pulp fibres, between 21 and 29 weight-% PET-fibres, between 13 and 21 weight-% PP-fibres, and between 1.8 and 2.6 weight-% dry solids of vinyl acetate-ethylene copolymer dispersion, and wherein said PET- and PP-fibres exhibit fibre dimensions within a range of 1.5-1.9 dtex and 15-25 mm.
